(19) United States
(12) Patent Application Publication
(10) Pub. No.: US 2024/0421911 A1
(43) Pub. Date: Dec. 19, 2024

(54) OPTICAL TRANSMISSION AND RECEPTION SYSTEM, OPTICAL TRANSMISSION AND RECEPTION METHOD, AND OPTICAL TRANSMISSION APPARATUS

(71) Applicant: Fujitsu Limited, Kawasaki-shi (JP)

(72) Inventor: Tomohiro NAGANUMA, Kawasaki (JP)

(73) Assignee: Fujitsu Limited, Kawasaki-shi (JP)

(21) Appl. No.: 18/678,196

(22) Filed: May 30, 2024

(30) Foreign Application Priority Data
Jun. 16, 2023 (JP) 2023-099119

(51) Int. Cl. H04B 10/54; H04B 10/2513; H04B 10/58

(52) U.S. Cl. CPC H04B 10/541; H04B 10/2513; H04B 10/58

(57) ABSTRACT

An optical transmission and reception system includes an optical transmission apparatus to acquire, in a frequency band of an electric data signal, from a first coefficient for amplifying an amplitude level of the frequency band in a high-frequency side, a partial coefficient that represents a negative portion of the amplitude level in the first coefficient, generate a second coefficient that reduces at least a part of the partial coefficient, generate a first compensation coefficient based on the first coefficient and the second coefficient, compensate for a loss that occurs in the optical transmission apparatus, based on the first compensation coefficient, and an optical reception apparatus to generate a second compensation coefficient based on a third coefficient and a fourth coefficient opposite to the second coefficient, and compensate for a loss that occurs in an optical transmission line, for the electric data signal, based on the second compensation coefficient.

### CROSS-REFERENCE TO RELATED APPLICATION

This application is based upon and claims the benefit of priority of the prior Japanese Patent Application No. 2023-99119, filed on Jun. 16, 2023, the entire contents of which are incorporated herein by reference.

### FIELD

The embodiment discussed herein is related to an optical transmission and reception system, an optical transmission and reception method, and an optical transmission apparatus.

### BACKGROUND

In digital coherent optical communication, a decrease in signal quality of an optical signal is reduced by using a digital signal processor (DSP) to compensate for a decrease factor of a signal characteristic that occurs in an optical transmission apparatus, an optical reception apparatus, or an optical transmission line. Examples of the decrease factor of the signal characteristic include inter-symbol interference, skew, chromatic dispersion, and the like caused by band characteristic.

As a method to be used when the compensation is executed, a method is used in which a decrease factor is canceled out by applying a characteristic opposite to the decrease factor occurring in an optical transmission apparatus, an optical reception apparatus, or an optical transmission line as a compensation characteristic to a signal characteristic of a main signal. For the compensation for inter-symbol interference caused by a band characteristic in an optical transmission apparatus, a method is used in which a characteristic opposite to a decrease factor in the optical transmission apparatus is used as a compensation characteristic and applied to a signal characteristic by a pre-equalization circuit in a DSP. A method of multiplying a signal characteristic by a characteristic opposite to a transmission line frequency characteristic is known.

Japanese Laid-open Patent Publication No. 2007-096513 is disclosed as related art.

### SUMMARY

According to an aspect of the embodiments, an optical transmission and reception system includes an optical transmission apparatus configured to acquire, in a frequency band of an electric data signal, from a first coefficient including a first characteristic for amplifying an amplitude level of the frequency band in a high-frequency side, a partial coefficient that represents a negative portion of the amplitude level in the first characteristic, generate a second coefficient including a second characteristic that reduces at least a part of the partial coefficient, generate a first compensation coefficient based on the first coefficient and the second coefficient, compensate for a loss that occurs in the optical transmission apparatus for an electric data signal to be converted to an optical signal to be transmitted from the optical transmission apparatus, based on the first compensation coefficient, and an optical reception apparatus configured to generate a second compensation coefficient based on a third coefficient including a third characteristic and a fourth coefficient including a fourth characteristic opposite to the second characteristic, the third coefficient and the fourth coefficient being coefficients for amplifying the electric data signal, and compensate for a loss that occurs in an optical transmission line through which the optical reception apparatus receives the optical signal transmitted from the optical transmission apparatus, for the electric data signal, based on the second compensation coefficient.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an example of an optical transmission and reception system;

FIG. 2A is a block diagram illustrating an example of a transmission-side DSP;

FIG. 2B is a block diagram illustrating an example of a reception-side DSP;

FIG. 3 is a block diagram illustrating an example of a transmission-side control unit according to a first embodiment;

FIG. 4 is an example of a first table according to the first embodiment;

FIG. 5 is a flowchart illustrating an example of an operation of an optical transmission apparatus according to the first embodiment;

FIG. 6 is a diagram describing an example of normalizing a first coefficient;

FIG. 7 is a diagram describing an example of normalizing an amplification target value;

FIG. 8 is a diagram describing a generation example of a second coefficient;

FIG. 9 is a diagram describing an example of overlapping the first coefficient and the second coefficient according to the first embodiment;

FIG. 10 is a diagram describing an example of an output signal from the optical transmission apparatus;

FIG. 11A is a diagram describing an example of an upper limit value of a DAC;

FIG. 11B is a diagram describing an example of clipping;

FIG. 11C is a diagram describing an example of scaling;

FIG. 12 is a block diagram illustrating an example of a reception-side control unit according to the first embodiment;

FIG. 13 is an example of a second table according to the first embodiment;

FIG. 14 is a flowchart illustrating an example of an operation of an optical reception apparatus according to the first embodiment;

FIG. 15 is a diagram describing an example of overlapping a third coefficient and a fourth coefficient;

FIG. 16 is a diagram describing an example of an output signal from the optical reception apparatus;

FIG. 17 is a block diagram illustrating an example of a transmission-side control unit according to a second embodiment;

FIG. 18 is a block diagram illustrating an example of an information generation unit;

FIG. 19 is a flowchart illustrating an example of an operation of an optical transmission apparatus according to the second embodiment;

FIG. 20 is a block diagram illustrating an example of a reception-side control unit according to the second embodiment;

FIG. 21 is a flowchart illustrating an example of an operation of an optical reception apparatus according to the second embodiment;

FIG. 22 is a block diagram illustrating an example of a transmission-side control unit according to a third embodiment;

FIG. 23 is a diagram illustrating an example of a first table according to the third embodiment;

FIG. 24 is a flowchart illustrating an example of an operation of an optical transmission apparatus according to the third embodiment;

FIG. 25 is a block diagram illustrating an example of a reception-side control unit according to the third embodiment;

FIG. 26 is an example of a second table according to the third embodiment;

FIG. 27 is a flowchart illustrating an example of an operation of an optical reception apparatus according to the third embodiment;

FIG. 28 is a diagram describing an example of a peaking characteristic;

FIG. 29 is a block diagram illustrating an example of a transmission-side control unit according to a fourth embodiment;

FIG. 30 is a flowchart illustrating an example of an operation of an optical transmission apparatus according to the fourth embodiment;

FIG. 31 is a diagram describing an example of a de-emphasis region;

FIG. 32 is a diagram describing an example of the second coefficient as a filter; and

FIG. 33 is a diagram describing an example of overlapping the first coefficient and the second coefficient according to a fourth embodiment.

### DESCRIPTION OF EMBODIMENTS

A digital analog converter (DAC) and a coherent driver modulator (CDM) may be disposed in order at a later stage of the DSP in the optical transmission apparatus. Depending on the CDM, in order to expand a bandwidth on a high-frequency side in the band characteristic of the optical transmission apparatus, a characteristic (hereinafter, referred to as a peaking characteristic) of amplifying an amplitude level in a low-frequency band or a middle-frequency band may be given to the band characteristic. In this manner, by giving the peaking characteristic to the band characteristic of the optical transmission apparatus, a decrease in signal characteristic due to a shortage of a bandwidth on the high-frequency side is reduced.

Meanwhile, in a case where a baud rate of the main signal is low, when the peaking characteristic is excessively given to the band characteristic of the optical transmission apparatus, the band characteristic of the optical transmission apparatus becomes excessively wide with respect to the signal characteristic of the main signal. From the viewpoint of improving transmission performance (for example, reducing noise or the like), it is desirable that the band characteristic of the optical transmission apparatus is close to a shape of the signal characteristic of the main signal and has a shape that does not distort the shape. Therefore, it is desirable to avoid the excessively wide band characteristic of the optical transmission apparatus with respect to the signal characteristic of the main signal.

Thus, it is assumed that the excessive peaking characteristic described above is canceled out by de-emphasis generated in the DSP disposed at a previous stage of the DAC. The de-emphasis is, for example, a characteristic (or a method) of decreasing an amplitude level to cancel out the peaking characteristic. Meanwhile, since the de-emphasis is a characteristic of decreasing the amplitude level, the occurrence of the de-emphasis may cause a decrease in quality of a signal input to the DAC. As a result, in a case where the decrease in quality of the signal occurs, a transmission characteristic of an optical signal may be decreased.

Hereinafter, embodiments of techniques to improve a transmission characteristic of an optical signal will be described with reference to the drawings.

### First Embodiment

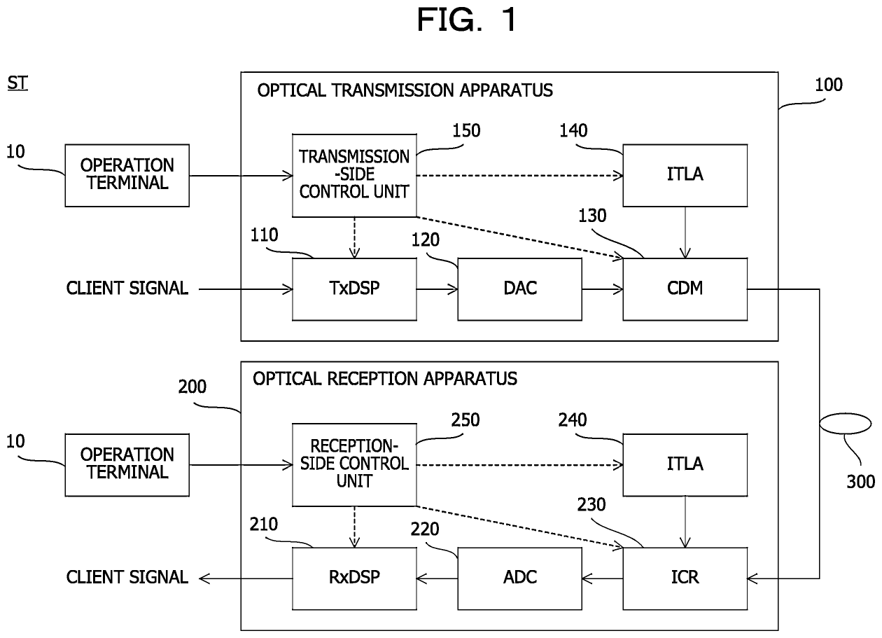

As illustrated in FIG. 1, an optical transmission and reception system ST includes an optical transmission apparatus 100 and an optical reception apparatus 200. The optical transmission apparatus 100 and the optical reception apparatus 200 are coupled to each other via an optical transmission line 300.

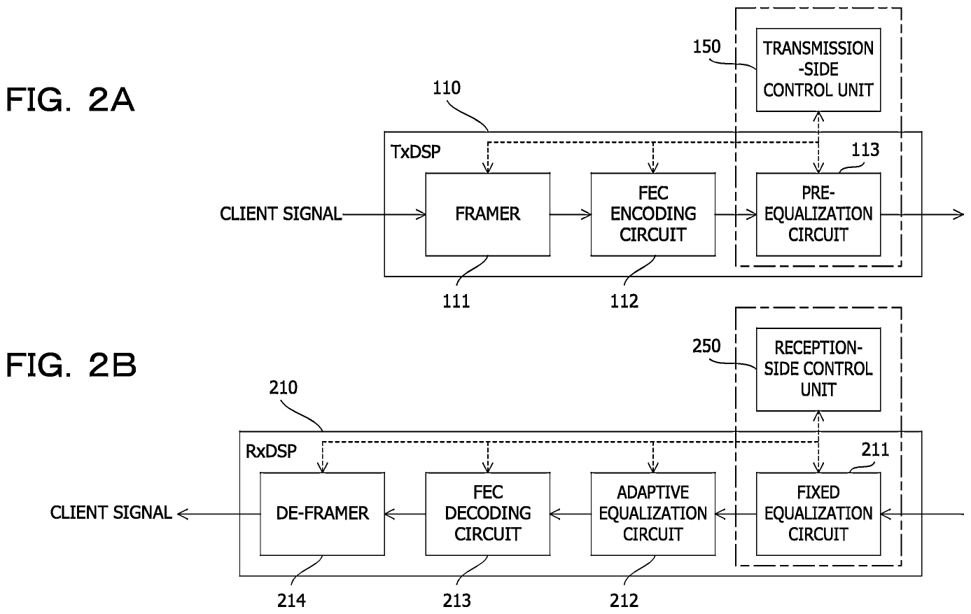

First, the optical transmission apparatus 100 will be described in detail. The optical transmission apparatus 100 includes a transmission-side DSP (hereinafter, referred to as a TxDSP) 110, a DAC 120, a coherent driver modulator (CDM) 130, an integrable tunable laser assembly (ITLA) 140, and a transmission-side control unit 150. The DAC 120 is an example of a conversion unit. The ITLA 140 is an example of a light source. The transmission-side control unit 150 is an example of a first setting unit. As illustrated in FIG. 2A, the TxDSP 110 includes a framer 111, a forward error correction (FEC) encoding circuit 112, and a pre-equalization circuit 113. The pre-equalization circuit 113 is an example of a first compensation unit. The transmission-side control unit 150 may be included in the first compensation unit.

The framer 111 receives an electric client signal in a digital format from a client network. The client signal is, for example, an Ethernet (registered trademark) signal. The client signal may be a main signal or a control signal including only a parameter for adjusting a transmission characteristic or the like. The framer 111 receives the client signal from the client network, converts the client signal into an optical channel transport unit (OTU) frame, and outputs the OTU frame to the FEC encoding circuit 112. Accordingly, the OTU frame is input to the FEC encoding circuit 112 from the framer 111.

The FEC encoding circuit 112 generates an FEC as an example of an error correction code of the OTU frame, and adds the FEC into the OTU frame. The FEC encoding circuit 112 outputs the OTU frame as an electric data signal to the pre-equalization circuit 113. A mapping circuit may be provided between the FEC encoding circuit 112 and the pre-equalization circuit 113. The mapping circuit maps bit data of the OTU frame to a symbol by performing digital modulation processing in accordance with a baud rate and a modulation scheme (for example, a multi-level modulation scheme) set by the transmission-side control unit 150. The mapping circuit outputs the electric data signal obtained by the digital modulation processing to the pre-equalization circuit 113.

For the data signal, the pre-equalization circuit 113 compensates for various losses occurring in the optical transmission apparatus 100 in advance, based on a first compensation coefficient to be described below. For example, the pre-equalization circuit 113 performs a skew compensation, a band characteristic compensation, and the like. The pre-equalization circuit 113 outputs the data signal after the compensation to the DAC 120.

Although details will be described below, the pre-equalization circuit 113 performs scaling on the data signal. The scaling is processing for reducing an amplitude level of a data signal having the amplitude level equal to or less than an upper limit value of the DAC 120. The amplitude level is a signal intensity (for example, signal power) of a data signal. For example, the scaling is processing of lowering the amplitude level of the data signal as a whole to a value equal to or less than the upper limit value of the DAC 120. Therefore, in a case where the amplitude level of the data signal exceeds the upper limit value of the DAC 120, it is possible to avoid clipping in which the amplitude level of the data signal is partially stuck to the upper limit value of the DAC 120.

With reference to FIG. 1, the DAC 120 converts a format of the data signal from a digital format into an analog format, and outputs the data signal to the CDM 130. The CDM 130 includes a driver circuit, an optical modulator, a polarization beam splitter, a polarization beam combiner, and the like. The CDM 130 separates transmission light input from the ITLA 140 into H polarization and V polarization, and optically modulates the H polarization and the V polarization with the data signal. The CDM 130 generates an optical signal by multiplexing the modulated light of the H polarization and the modulated light of the V polarization, and outputs the optical signal to the optical transmission line 300. In this manner, the optical transmission apparatus 100 converts a data signal into an optical signal, and transmits the optical signal toward the optical reception apparatus 200.

As illustrated in FIG. 1, the transmission-side control unit 150 includes a processor and a memory, and controls each operation of the TxDSP 110, the CDM 130, and the ITLA 140. The processor includes, for example, a central processing unit (CPU). At a time of controlling the operation of the TxDSP 110, as illustrated in FIG. 2A, the transmission-side control unit 150 controls the operations of the framer 111, the FEC encoding circuit 112, and the pre-equalization circuit 113. According to control from an operation terminal 10 (see FIG. 1), the transmission-side control unit 150 performs various settings for the framer 111, the FEC encoding circuit 112, and the pre-equalization circuit 113. The operation terminal 10 may be a personal computer (PC) or a smart terminal (for example, a tablet terminal or the like). The transmission-side control unit 150 sets a line rate for the framer 111, and sets a redundancy of an FEC for the FEC encoding circuit 112.

The transmission-side control unit 150 generates the first compensation coefficient described above, and sets the first compensation coefficient for the pre-equalization circuit 113. Based on a first coefficient and a second coefficient, the transmission-side control unit 150 generates the first compensation coefficient. For example, the transmission-side control unit 150 generates the first compensation coefficient by overlapping the first coefficient and the second coefficient on each other. The first coefficient is a coefficient for amplifying an amplitude level in a band on a high-frequency side, in a frequency band of a data signal. By using the first coefficient, it is possible to compensate for a loss (for example, inter-symbol interference due to band characteristic) occurring in the optical transmission apparatus 100. On the other hand, the second coefficient is a coefficient for amplifying an amplitude level in a band on a low-frequency side, in the frequency band of the data signal. By using the second coefficient, it is possible to make a signal quality (for example, SNR) of the data signal, which is equal to or more than a predetermined value at which deterioration in transmission performance of the optical signal is avoided.

Next, details of the optical reception apparatus 200 will be described. As illustrated in FIG. 1, the optical reception apparatus 200 includes a reception-side DSP (hereinafter, referred to as an RxDSP) 210, an analogue digital converter (ADC) 220, an integrated coherent receiver (ICR) 230, an ITLA 240, and a reception-side control unit 250. The ITLA 240 is an example of a light source. The reception-side control unit 250 is an example of a second setting unit.

An optical signal that is transmitted from the optical transmission apparatus 100 and passes through the optical transmission line 300 is input to the ICR 230. The ICR 230 includes a polarization beam splitter, an optical-electric converter, and the like. The ICR 230 separates the optical signal into respective components of H polarization and V polarization, receives the optical signal with local light emission input from the ITLA 240, converts the optical signal into an electric data signal, and outputs the electric data signal to the ADC 220. For example, the optical reception apparatus 200 receives an optical signal input from the optical transmission apparatus 100 via the optical transmission line 300, and converts the optical signal into a data signal. The ADC 220 converts a format of the data signal from an analog format to a digital format, and outputs the data signal to the RxDSP 210.

As illustrated in FIG. 2B, the RxDSP 210 includes a fixed equalization circuit 211, an adaptive equalization circuit 212, an FEC decoding circuit 213, and a de-framer 214. The fixed equalization circuit 211 is an example of a second compensation unit. The reception-side control unit 250 may be included in the second compensation unit.

For the data signal, the fixed equalization circuit 211 performs a fixed compensation for a loss occurring in the optical transmission apparatus 100, the optical reception apparatus 200, and the optical transmission line 300, based on a second compensation coefficient to be described below. For example, the fixed equalization circuit 211 performs a chromatic dispersion compensation, a skew compensation, and a band characteristic compensation. The fixed equalization circuit 211 outputs the data signal after the compensation to the adaptive equalization circuit 212.

For the data signal, the adaptive equalization circuit 212 performs an adaptive compensation on waveform distortion of an optical signal caused by polarization mode dispersion or polarization dependent loss occurring over the optical transmission line 300 based on a dynamic parameter. The adaptive equalization circuit 212 outputs the data signal after the compensation as an OTU frame to the FEC decoding circuit 213. A de-mapping circuit may be provided between the adaptive equalization circuit 212 and the FEC decoding circuit 213. The de-mapping circuit is a circuit that detects a symbol by performing de-mapping processing, converts the symbol into bit data, and demodulates the OTU frame from the data signal.

The FEC decoding circuit 213 extracts an FEC from the OTU frame, and performs a data error correction. The FEC decoding circuit 213 outputs the OTU frame to the de-framer 214. The de-framer 214 receives the OTU frame from the FEC decoding circuit 213, converts the OTU frame into a client signal, and transmits the client signal to the client network.

As illustrated in FIG. 1, the reception-side control unit 250 includes a processor and a memory, and controls each operation of the RxDSP 210, the ICR 230, and the ITLA 240. At a time of controlling the operation of the RxDSP 210, as illustrated in FIG. 2B, the reception-side control unit 250 controls the operations of the fixed equalization circuit 211, the adaptive equalization circuit 212, the FEC decoding circuit 213, and the de-framer 214. According to control from the operation terminal 10 (see FIG. 1), the reception-side control unit 250 performs various settings for the fixed equalization circuit 211, the adaptive equalization circuit 212, the FEC decoding circuit 213, and the de-framer 214.

The reception-side control unit 250 generates the second compensation coefficient described above, and sets the second compensation coefficient for the fixed equalization circuit 211. The reception-side control unit 250 generates the second compensation coefficient based on a third coefficient and a fourth coefficient. For example, the reception-side control unit 250 generates the second compensation coefficient by overlapping the third coefficient and the fourth coefficient on each other. The third coefficient is a coefficient for amplifying a data signal. By using the third coefficient, it is possible to compensate for a loss occurring in the optical reception apparatus 200 or the optical transmission line 300. The fourth coefficient is a coefficient for amplifying (for example, attenuating) a data signal based on an amplification characteristic opposite to an amplification characteristic of the second coefficient. By using the fourth coefficient, it is possible to cancel out the second coefficient adopted for the purpose of temporarily improving a signal quality.

In this manner, since the optical transmission apparatus 100 side amplifies an amplitude level of a band on a low-frequency side based on the second coefficient to make the signal quality of the data signal equal to or more than a predetermined value, and the optical reception apparatus 200 side restores the signal quality of the data signal based on the fourth coefficient having an amplification characteristic opposite to the second coefficient, it is possible to improve the characteristic of the entire signal.

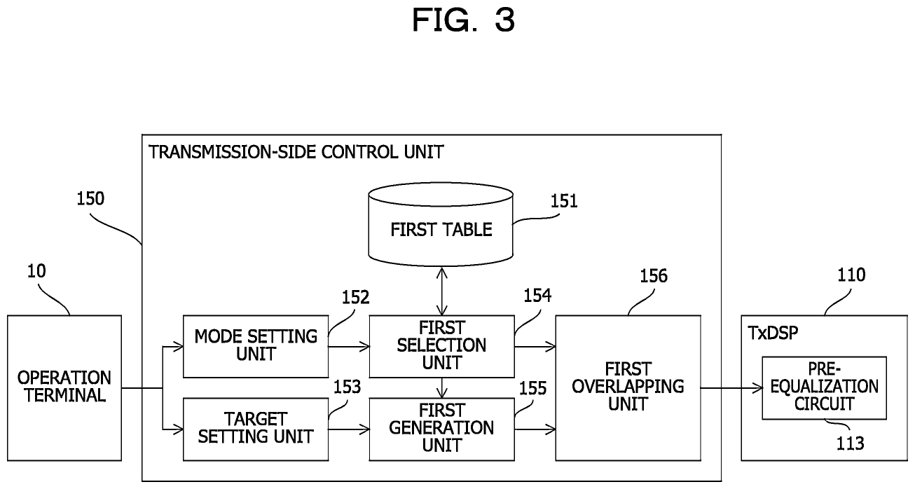

Next, details of the transmission-side control unit 150 according to the first embodiment will be described with reference to FIGS. 3 to 11C.

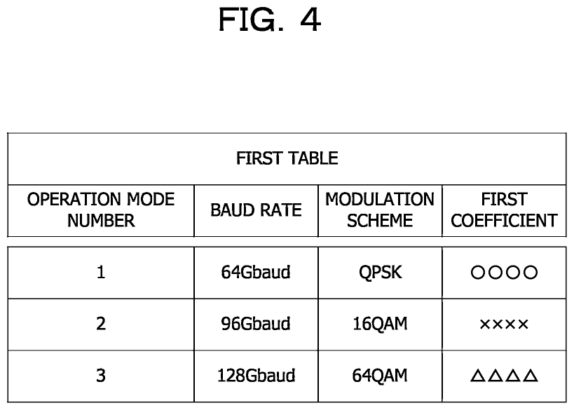

First, as illustrated in FIG. 3, the transmission-side control unit 150 includes a first table 151, a mode setting unit 152, and a target setting unit 153. The transmission-side control unit 150 includes a first selection unit 154, a first generation unit 155, and a first overlapping unit 156. As illustrated in FIG. 4, the first table 151 includes an operation mode number, a baud rate, a modulation scheme, and a first coefficient in association with each other. The operation mode number in the first table 151 is an identifier for identifying an operation mode of the optical transmission apparatus 100. When the operation mode number is designated, it is possible to determine the baud rate, the modulation scheme, and the first coefficient associated with the designated operation mode number. Therefore, it is possible to cause the optical transmission apparatus 100 to operate with the baud rate, the modulation scheme, and the first coefficient that correspond to the designated operation mode number. Without providing the operation mode number, at least one of the baud rate and the modulation scheme may be designated, and the first coefficient may be determined in accordance with at least one of the designated baud rate and the modulation scheme.

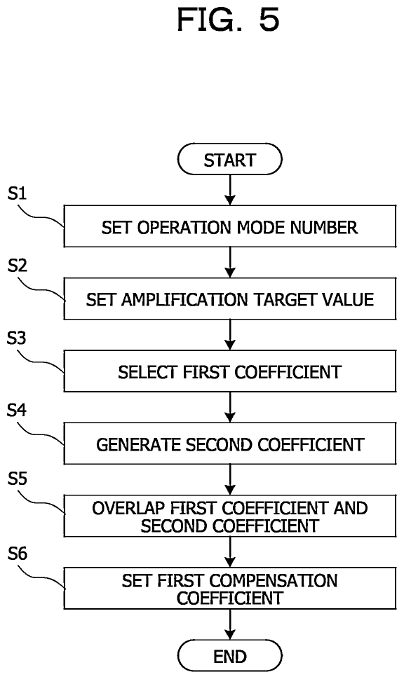

As illustrated in FIG. 5, the mode setting unit 152 sets an operation mode number in the mode setting unit 152 itself under control of the operation terminal 10 (operation S1). When the operation mode number is set, the target setting unit 153 sets an amplification target value in the target setting unit 153 itself according to the control from the operation terminal 10 (operation S2). The amplification target value is a target value of an amplitude level in a band on a low-frequency side, which is to be amplified. The processing in operation S1 and the processing in S2 may be performed at the same timing, or may be performed at different timings.

When the amplification target value is set, the first selection unit 154 selects a first coefficient corresponding to the operation mode number set in the mode setting unit 152 together with the baud rate and the modulation scheme from the first table 151 (operation S3). The first selection unit 154 outputs the selected baud rate, modulation scheme, and first coefficient to the first overlapping unit 156. For the first coefficient, the first selection unit 154 also outputs the first coefficient to the first generation unit 155. When the first coefficient is output from the first selection unit 154, the first generation unit 155 generates a second coefficient based on the amplification target value set in the target setting unit 153 and the first coefficient (operation S4).

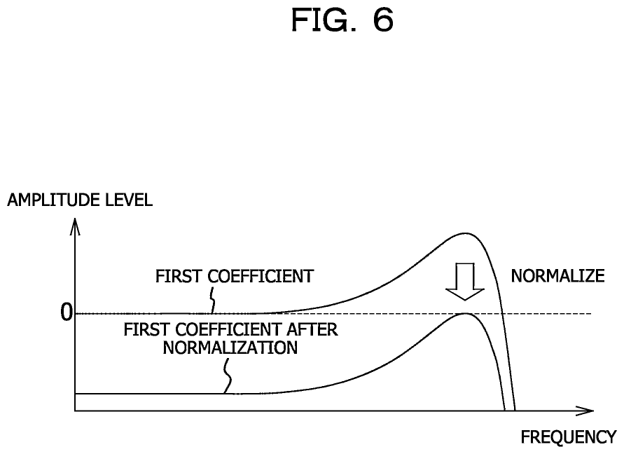

For example, as illustrated in FIG. 6, first, the first generation unit 155 normalizes a characteristic of a first coefficient. The normalization is processing for decreasing the characteristic of the first coefficient as a whole such that the maximum amplitude level in the first coefficient is “0 (zero)”. The normalization may be performed such that the maximum amplitude level in the first coefficient is an upper limit value of the DAC 120. When the characteristic of the first coefficient is normalized, the first generation unit 155 calculates a relative attenuation amount based on the amplitude level “0” for each frequency component.

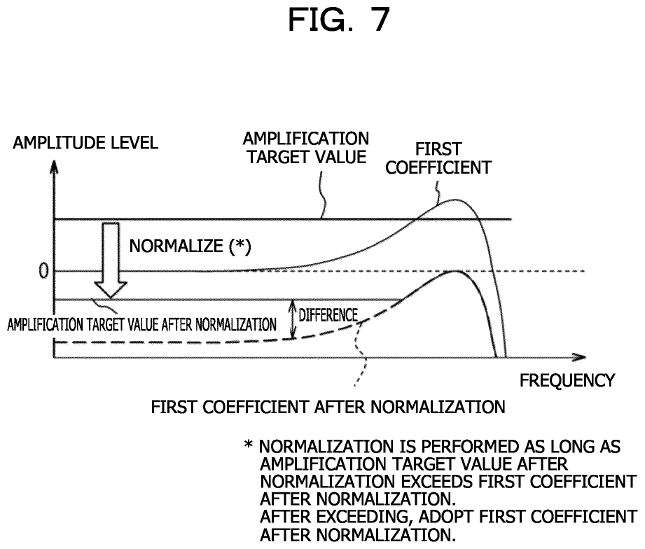

Next, as illustrated in FIG. 7, the first generation unit 155 normalizes a characteristic of an amplification target value, in the same manner as the normalization for the first coefficient. For example, the first generation unit 155 attenuates the characteristic of the amplification target value as a whole for each frequency component by the same attenuation amount as the attenuation amount of the characteristic of the first coefficient. Therefore, the characteristic of the amplification target value after the normalization less than the amplitude level “0” is obtained. When obtaining the characteristic of the amplification target value after the normalization, the first generation unit 155 calculates a difference between the amplification target value after the normalization and the first coefficient after the normalization (amplification target value after normalization-first coefficient after normalization) for each frequency component. In a case where the amplification target value after the normalization is equal to or less than the first coefficient after the normalization (for example, the difference ≤0), the first generation unit 155 adopts the first coefficient after the normalization as the amplification target value after the normalization. Therefore, the first generation unit 155 obtains the characteristic of the amplification target value after the normalization partially including the first coefficient after the normalization on the high-frequency side. A frequency band in which the amplification target value after the normalization exceeds the first coefficient after the normalization (for example, the difference >0) is described as a low-frequency band in the present specification.

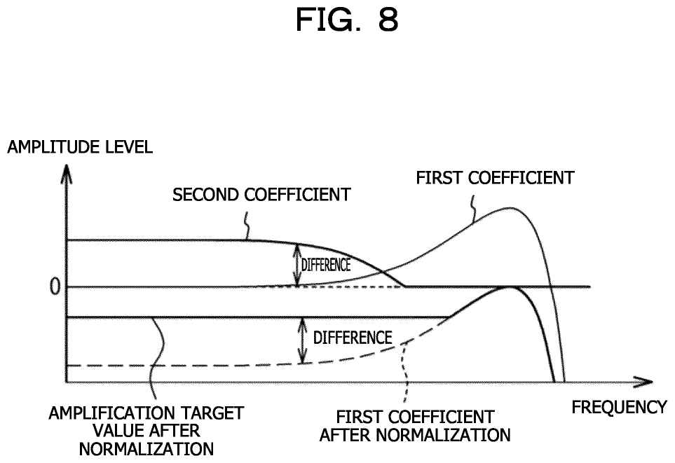

Next, as illustrated in FIG. 8, the first generation unit 155 generates a second coefficient by subtracting the first coefficient from the difference (for example, difference-first coefficient before normalization). For example, the first generation unit 155 generates a characteristic obtained by subtracting the first coefficient from the difference, as a characteristic of the second coefficient.

In a case where the characteristic of the second coefficient is less than the amplitude level “0”, the first generation unit 155 fixes the characteristic of the second coefficient to the amplitude level “0”. For example, when the characteristic of the second coefficient is less than the amplitude level “0”, there is a possibility that a signal quality of a data signal by the second coefficient is less than a predetermined value. By fixing the characteristic of the second coefficient to the amplitude level “0”, this possibility may be avoided. The first generation unit 155 outputs the generated second coefficient to the first overlapping unit 156. The operation terminal 10 may access the first generation unit 155 to refer to the second coefficient, or may acquire the second coefficient from the first generation unit 155.

With reference to FIG. 5, the first overlapping unit 156 overlaps the first coefficient output from the first selection unit 154 and the second coefficient output from the first generation unit 155 (operation S5). The first overlapping unit 156 generates the first compensation coefficient described above by overlapping the first coefficient and the second coefficient on each other. When the first compensation coefficient is generated, the first overlapping unit 156 sets the first compensation coefficient to the pre-equalization circuit 113 of the TxDSP 110 (operation S6), and the processing ends.

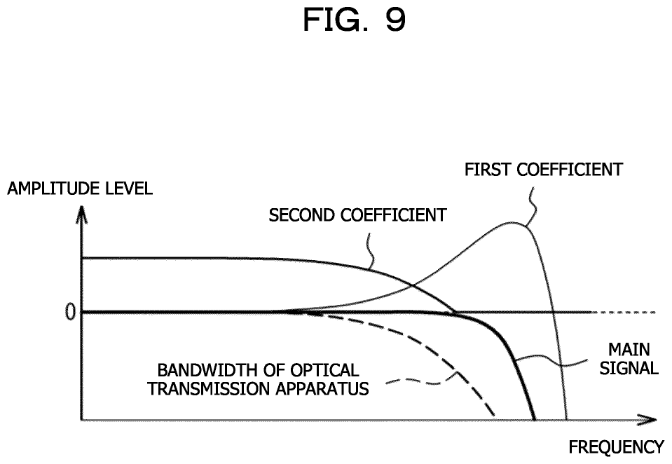

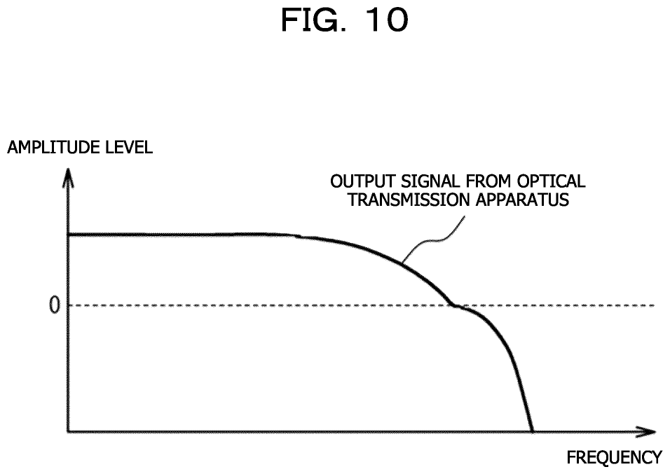

Therefore, as illustrated in FIG. 9, for example, in a case where the data signal is a main signal and a bandwidth of the optical transmission apparatus 100 is insufficient for the main signal, the first compensation coefficient generated by overlapping the first coefficient and the second coefficient may be applied to the main signal. The first coefficient has an upward peak of the amplitude level of the band on the high-frequency side, so compensates for a loss such as inter-symbol interference due to a band characteristic occurring in the optical transmission apparatus 100. On the other hand, in the second coefficient, in a partial band on the lower frequency side than the peak of the first coefficient, the amplitude level of the band is increased as the frequency is decreased, so that compensates for a decrease in signal quality on the low-frequency band side due to scaling. Accordingly, the characteristic of the second coefficient remains without being canceled out by the bandwidth of the optical transmission apparatus 100, and as illustrated in FIG. 10, an output signal in which the remaining second coefficient is applied to the main signal is output from the optical transmission apparatus 100 as an optical signal. The first overlapping unit 156 sets the baud rate and the modulation scheme output from the first selection unit 154 to a mapping circuit (not illustrated) of the TxDSP 110. The set baud rate and modulation scheme are used for transmission of the main signal.

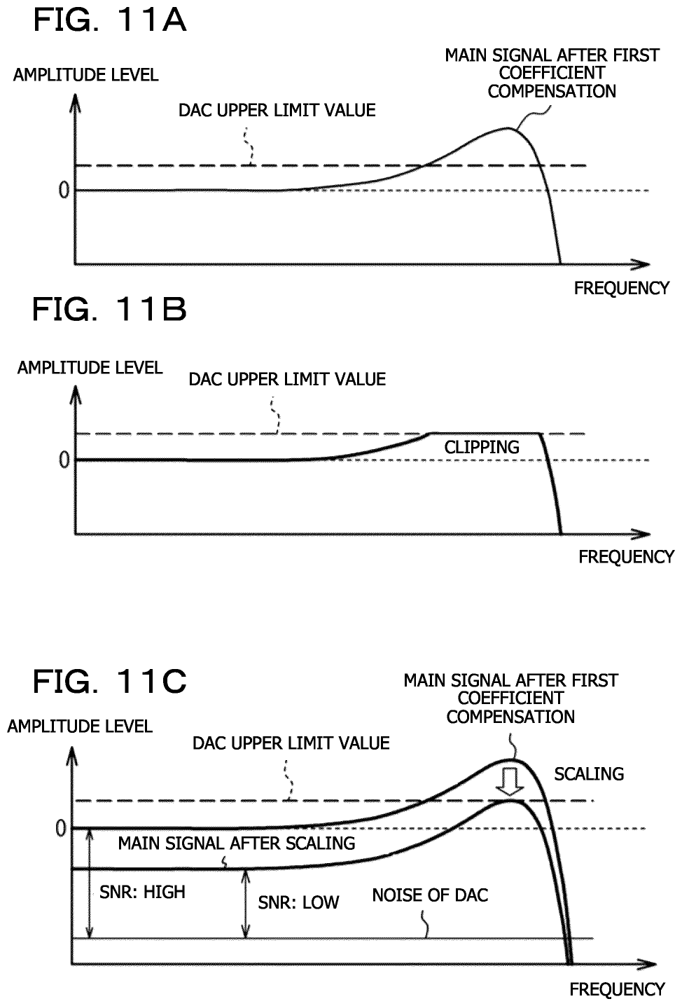

The clipping and the scaling described above will be described with reference to FIGS. 11A to 11C.

First, as illustrated in FIG. 11A, the DAC 120 has an upper limit value for an amplitude level of an electric data signal that may be output. For example, in a case where the characteristic of the main signal after the first coefficient compensation is equal to or more than this upper limit value, as illustrated in FIG. 11B, clipping in which a part of the main signal equal to or more than the upper limit value is stuck to the upper limit value occurs regardless of the original characteristic. Since the characteristic of the main signal is changed as compared with the original characteristic due to the clipping, the signal quality of the main signal deteriorates.

As illustrated in FIG. 11C, in order to avoid the clipping, it is also assumed that the characteristic of the main signal is input to the DAC 120 after scaling for reducing the amplitude level to a level at which the clipping does not occur is performed in the pre-equalization circuit 113. Meanwhile, there is a case where the transmission performance of the main signal after the scaling deteriorates due to a relationship with noise of the DAC 120. For example, in a low-frequency band, in a case of a main signal before the scaling, it is possible to ensure that an SNR between the main signal and the noise of the DAC 120 has a sufficiently high value such that the deterioration in the transmission performance of the main signal may be ignored. Meanwhile, in a case of the main signal after the scaling, the SNR between the main signal and the noise of the DAC 120 is decreased, and the transmission performance of the main signal deteriorates. Therefore, in the present embodiment, the characteristic of the low-frequency band of the data signal such as the main signal is improved by the second coefficient.

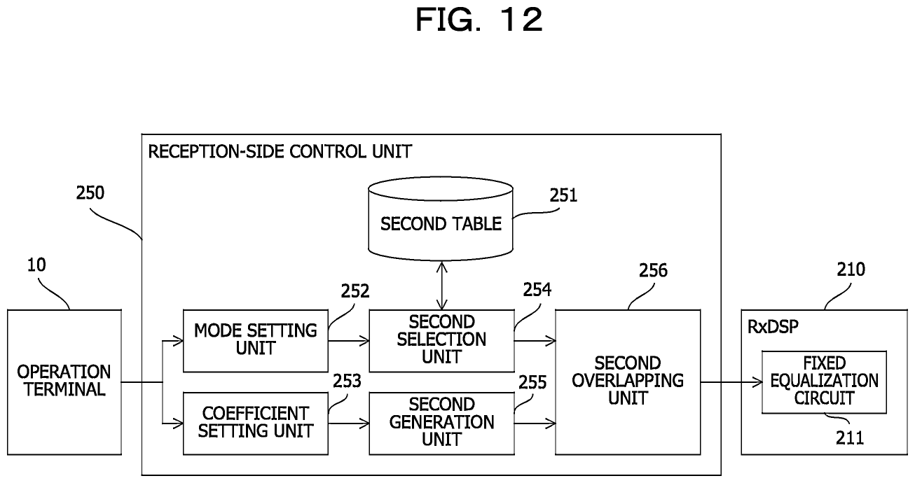

Next, details of the reception-side control unit 250 according to the first embodiment will be described with reference to FIGS. 12 to 16.

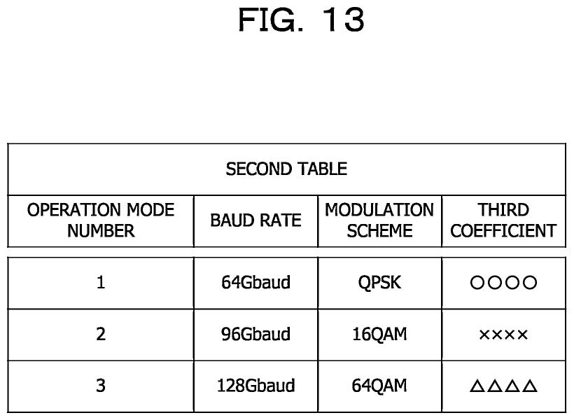

First, as illustrated in FIG. 12, the reception-side control unit 250 includes a second table 251, a mode setting unit 252, and a coefficient setting unit 253. The reception-side control unit 250 includes a second selection unit 254, a second generation unit 255, and a second overlapping unit 256. As illustrated in FIG. 13, the second table 251 includes an operation mode number, a baud rate, a modulation scheme, and a third coefficient in association with each other. The operation mode number in the second table 251 is an identifier for identifying an operation mode of the optical reception apparatus 200. When the operation mode number is designated, it is possible to determine the baud rate, the modulation scheme, and the third coefficient associated with the designated operation mode number. Therefore, it is possible to cause the optical reception apparatus 200 to operate with the baud rate, the modulation scheme, and the third coefficient that correspond to the designated operation mode number. Without providing the operation mode number, at least one of the baud rate and the modulation scheme may be designated, and the third coefficient may be determined in accordance with at least one of the designated baud rate and the modulation scheme.

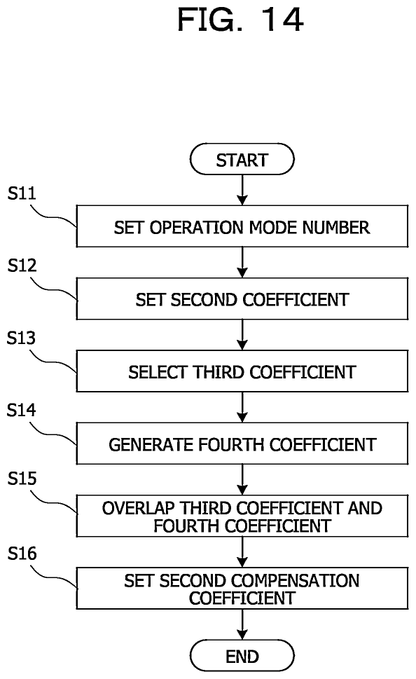

As illustrated in FIG. 14, the mode setting unit 252 sets an operation mode number in the mode setting unit 252 itself under control of the operation terminal 10 (operation S11). When the operation mode number is set, the coefficient setting unit 253 sets a second coefficient in the coefficient setting unit 253 itself in accordance with the control from the operation terminal 10 (operation S12). For the setting of the second coefficient, the operation terminal 10 may acquire the second coefficient from the transmission-side control unit 150 (for example, the first generation unit 155), after the operation terminal 10 completes the setting for the transmission-side control unit 150. By recoupling the operation terminal 10 from the optical transmission apparatus 100 to the optical reception apparatus 200, the operation terminal 10 may set the second coefficient to the coefficient setting unit 253. The processing in operation S11 and the processing in S12 may be performed at the same timing, or may be performed at different timings.

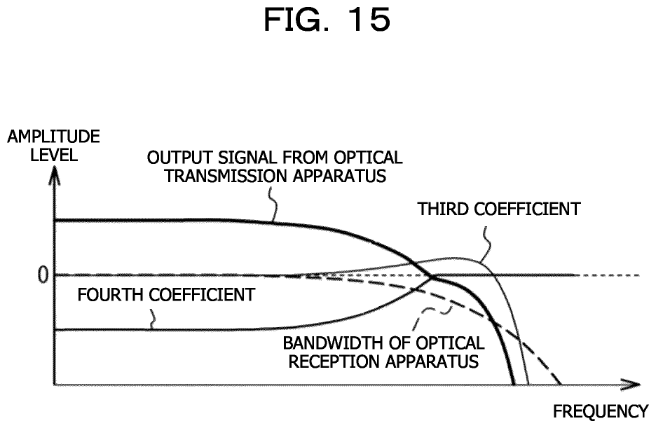

When the operation mode number is set in the mode setting unit 252, the second selection unit 254 selects a third coefficient corresponding to the set operation mode number from the second table 251 together with the baud rate and the modulation scheme (operation S13). As illustrated in FIG. 15, in the third coefficient, in a partial band on the lower frequency side than the peak of the first coefficient, the amplitude level of the band is decreased as the frequency is decreased. The second selection unit 254 outputs the selected baud rate, modulation scheme, and third coefficient to the second overlapping unit 256.

When the second coefficient is set in the coefficient setting unit 253, the second generation unit 255 generates a fourth coefficient based on the second coefficient (operation S14). For example, as illustrated in FIG. 15, the second generation unit 255 generates the fourth coefficient based on an amplification characteristic opposite to a characteristic of the second coefficient. For example, the second generation unit 255 generates the amplification characteristic opposite to the characteristic of the second coefficient as a characteristic of the fourth coefficient. The second generation unit 255 outputs the generated fourth coefficient to the second overlapping unit 256. The processing in operation S13 and the processing in S14 may be performed at the same timing, or may be performed at different timings.

With reference to FIG. 14, the second overlapping unit 256 overlaps the third coefficient output from the second selection unit 254 and the fourth coefficient output from the second generation unit 255 (operation S15). The second overlapping unit 256 generates the second compensation coefficient described above by overlapping the third coefficient and the fourth coefficient on each other. When the second compensation coefficient is generated, the second overlapping unit 256 sets the second compensation coefficient to the fixed equalization circuit 211 of the RxDSP 210 (operation S16), and the processing ends.

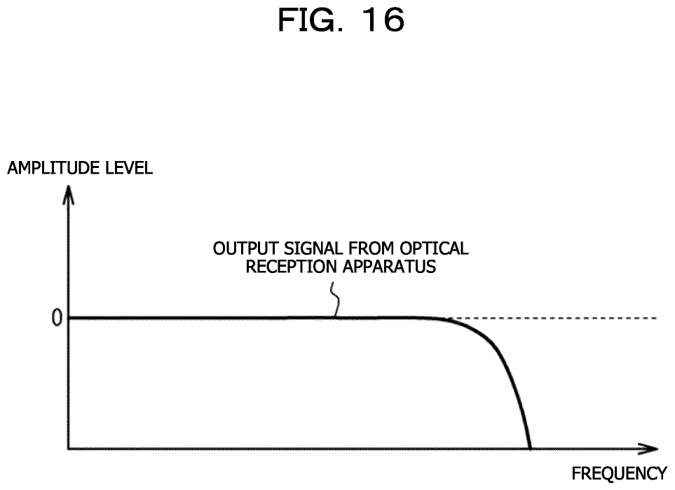

Therefore, as illustrated in FIG. 15, for example, in a case where the data signal is a main signal and the bandwidth of the optical reception apparatus 200 is insufficient for the main signal, the second compensation coefficient generated by overlapping the third coefficient and the fourth coefficient may be applied to the main signal. By using the third coefficient, it is possible to compensate for a loss such as inter-symbol interference due to a band characteristic generated in the optical reception apparatus 200 or the optical transmission line 300. By using the fourth coefficient, it is possible to cancel out the second coefficient adopted for the purpose of temporarily improving a signal quality. Accordingly, as illustrated in FIG. 16, the output signal in which the second compensation coefficient is applied to the main signal is output from the optical reception apparatus 200 as the client signal. The second overlapping unit 256 sets the baud rate and the modulation scheme output from the second selection unit 254 to a de-mapping circuit (not illustrated) of the RxDSP 210.

As described above, with the first embodiment, in a case where the DAC 120 has an upper limit value for the characteristic of the amplitude level of the electric signal that may be output, even when normalization such as scaling is executed, it is possible to reduce a decrease in signal quality in a low-frequency band and to improve the transmission characteristic of the optical signal.

### Second Embodiment

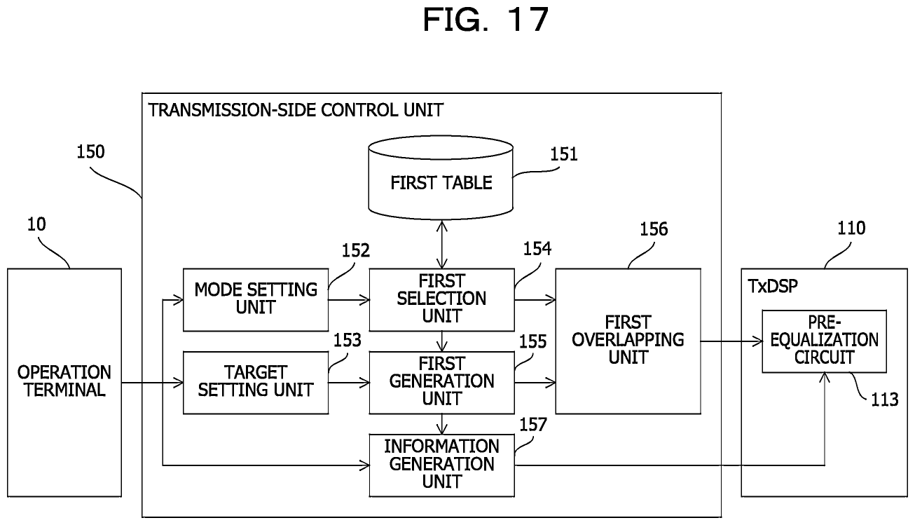

Next, with reference to FIGS. 17 to 21, a second embodiment of the present disclosure will be described. The first embodiment described above is described in which the transmission-side control unit 150 generates the second coefficient, and the reception-side control unit 250 uses the second coefficient via the operation terminal 10 to generate the fourth coefficient. With the second embodiment, a second coefficient generated by the transmission-side control unit 150 is transmitted from the optical transmission apparatus 100 to the optical reception apparatus 200, and the reception-side control unit 250 uses the received second coefficient to generate a fourth coefficient.

First, a configuration and an operation of the transmission-side control unit 150 according to the second embodiment will be described with reference to FIGS. 17 to 19. In FIG. 17, a configuration in the same manner as the configuration of the transmission-side control unit 150 according to the first embodiment is denoted by the same reference signs, and the description thereof is omitted.

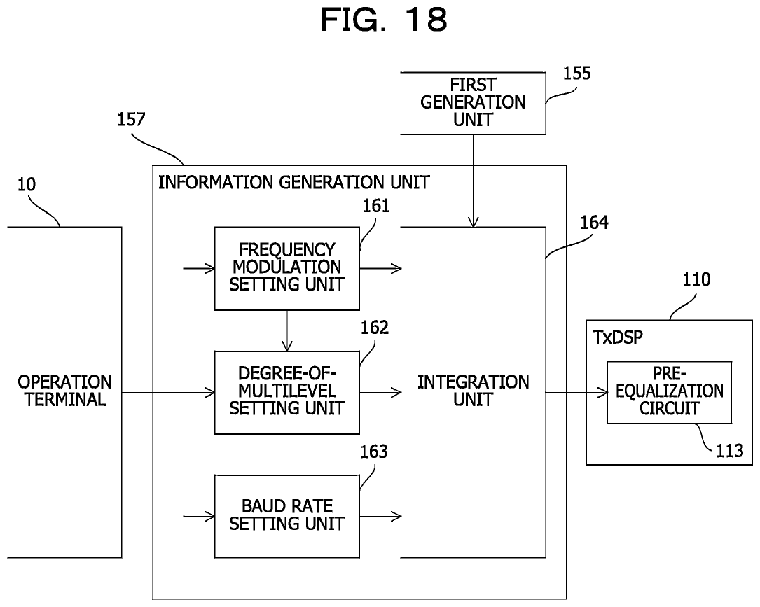

As illustrated in FIG. 17, the transmission-side control unit 150 according to the second embodiment is different from the transmission-side control unit 150 according to the first embodiment, in that the transmission-side control unit 150 further includes an information generation unit 157. As illustrated in FIG. 18, the information generation unit 157 includes a frequency modulation setting unit 161, a degree-of-multilevel setting unit 162, a baud rate setting unit 163, and an integration unit 164.

The first generation unit 155 outputs the generated second coefficient to the integration unit 164. According to control from the operation terminal 10, the frequency modulation setting unit 161 sets whether or not to use frequency modulation of a transmission frequency to the frequency modulation setting unit 161 itself. According to the control from the operation terminal 10, the degree-of-multilevel setting unit 162 sets a degree of multi-level less than a degree of multilevel used for a main signal to the degree-of-multi-level setting unit 162 itself. According to the control from the operation terminal 10, the baud rate setting unit 163 sets a baud rate less than a baud rate used for the main signal to the baud rate setting unit 163 itself. These various settings may be made at the same timing as or at different timings from the timing of the setting of the operation mode number or the setting of the amplification target value.

For example, in a case where information indicating that the frequency modulation is to be used is set in the frequency modulation setting unit 161, the integration unit 164 generates transmission information in which one or both of the information indicating that the frequency modulation is to be used and information indicating the baud rate set in the baud rate setting unit 163, and information of the second coefficient are integrated. In a case where information indicating that the frequency modulation is not to be used is set in the frequency modulation setting unit 161, the integration unit 164 generates transmission information in which one or both of the degree of multilevel set in the degree-of-multilevel setting unit 162 and the baud rate set in the baud rate setting unit 163, and the information of the second coefficient are integrated.

The integration unit 164 outputs the generated transmission information to the pre-equalization circuit 113 of the TxDSP 110. Based on the transmission information, the pre-equalization circuit 113 generates an electric control signal that includes the transmission information, and outputs the electric control signal to the DAC 120. Therefore, the control signal having a setting different from a setting of the main signal is transmitted from the optical transmission apparatus 100. Therefore, the optical reception apparatus 200 may identify the control signal and the main signal. Since the frequency modulation is not compatible with phase modulation such as quadrature phase shift keying (QPSK) in a case where the frequency modulation is used, the use of the degree of multilevel is avoided.

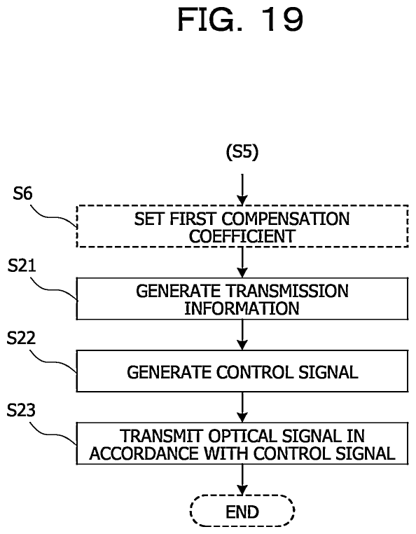

As illustrated in FIG. 19, when the first overlapping unit 156 executes the processing of operation S6, the information generation unit 157 generates transmission information as described above (operation S21), and outputs the transmission information to the pre-equalization circuit 113. The pre-equalization circuit 113 generates a control signal that includes the transmission information (operation S22), and outputs the control signal to the DAC 120. Based on the control signal output to the DAC 120, the CDM 130 converts the control signal into an optical signal in accordance with the control signal, and transmits the optical signal toward the optical reception apparatus 200 (operation S23). In this manner, the optical transmission apparatus 100 transmits the control signal to the optical reception apparatus 200.

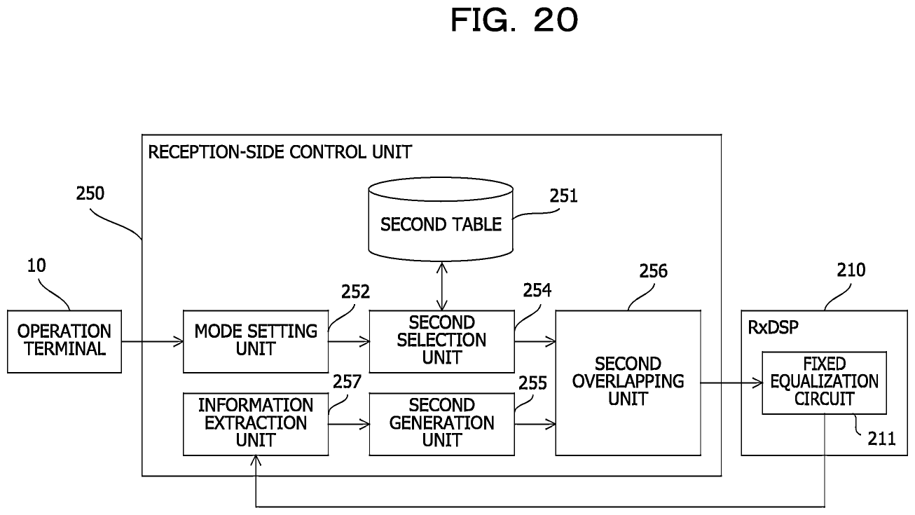

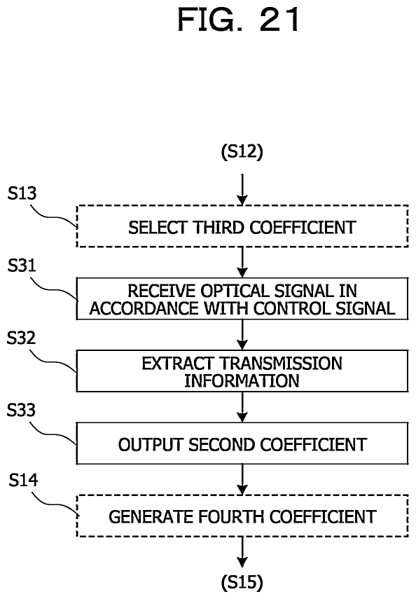

Next, a configuration and an operation of the reception-side control unit 250 according to the second embodiment will be described with reference to FIGS. 20 and 21. In FIG. 20, a configuration in the same manner as the configuration of the reception-side control unit 250 according to the first embodiment is denoted by the same reference signs, and the description thereof is omitted.

The reception-side control unit 250 according to the second embodiment is different from the reception-side control unit 250 according to the first embodiment, in that the reception-side control unit 250 further includes an information extraction unit 257. Based on a control signal in accordance with an optical signal received by the optical reception apparatus 200 (for example, ICR 230), the information extraction unit 257 extracts transmission information after digital demodulation in the fixed equalization circuit 211. The information extraction unit 257 outputs a second coefficient from the extracted transmission information to the second generation unit 255. Therefore, in the same manner as in the first embodiment, the second generation unit 255 may generate a fourth coefficient based on the second coefficient.

As illustrated in FIG. 21, when the second selection unit 254 executes the processing of operation S13, the ICR 230 receives the optical signal corresponding to the control signal (operation S31). When the ICR 230 receives the optical signal, the information extraction unit 257 extracts the transmission information from the control signal corresponding to the optical signal (operation S32), and outputs the second coefficient to the second generation unit 255 (operation S33). Therefore, the second generation unit 255 may execute the processing of operation S14.

As described above, with the second embodiment, the optical reception apparatus 200 may generate the fourth coefficient based on the second coefficient transmitted from the optical transmission apparatus 100 without resetting the second coefficient generated by the optical transmission apparatus 100 to the optical reception apparatus 200. Therefore, a setting burden on a person in charge of setting who operates the operation terminal 10 may be reduced. By omitting the setting processing of the second coefficient by the optical reception apparatus 200, a processing load may be reduced.

### Third Embodiment

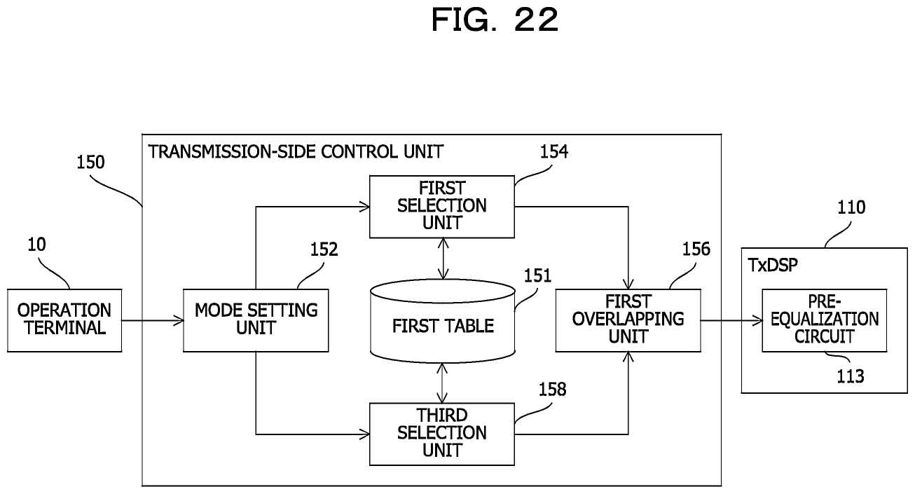

Next, with reference to FIGS. 22 to 27, a third embodiment of the present disclosure will be described. The first embodiment described above is described in which the transmission-side control unit 150 generates the second coefficient, and the reception-side control unit 250 uses the second coefficient via the operation terminal 10 to generate the fourth coefficient. According to the third embodiment, the transmission-side control unit 150 does not generate the second coefficient, but uses a second coefficient associated with the first coefficient in advance (for example, at a time of apparatus manufacture or the like) in an initial setting. The reception-side control unit 250 does not generate the fourth coefficient based on the second coefficient but uses a fourth coefficient associated with the third coefficient in advance by the initial setting.

First, a configuration and an operation of the transmission-side control unit 150 according to the third embodiment will be described with reference to FIGS. 22 to 24. In FIG. 22, a configuration in the same manner as the configuration of the transmission-side control unit 150 according to the first embodiment is denoted by the same reference signs, and the description thereof is omitted.

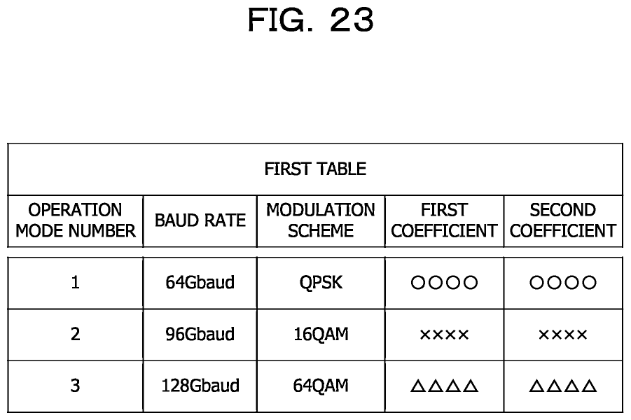

As illustrated in FIG. 22, the transmission-side control unit 150 according to the third embodiment is different from the transmission-side control unit 150 of the first embodiment, in that the transmission-side control unit 150 does not include the target setting unit 153 and the first generation unit 155 but further includes a third selection unit 158. As illustrated in FIG. 23, the first table 151 according to the third embodiment is different from the first table 151 according to the first embodiment, in that a second coefficient is associated with a first coefficient. The third selection unit 158 selects a second coefficient corresponding to an operation mode number set in the mode setting unit 152, from the first table 151. The third selection unit 158 outputs the selected second coefficient to the first overlapping unit 156. Therefore, the first overlapping unit 156 may overlap the first coefficient output from the first selection unit 154 and the second coefficient output from the third selection unit 158. For example, the first overlapping unit 156 may generate a first compensation coefficient.

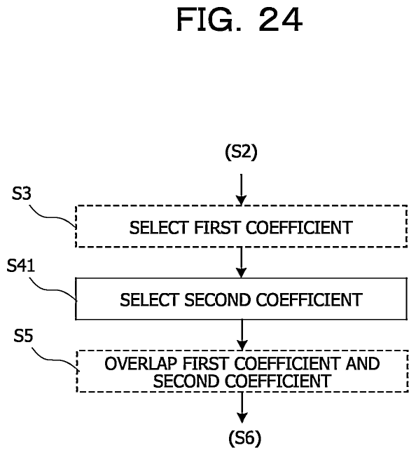

As illustrated in FIG. 24, when the first selection unit 154 executes the processing of operation S3, the third selection unit 158 selects a second coefficient as described above (operation S41), and outputs the second coefficient to the first overlapping unit 156. Therefore, the first overlapping unit 156 may execute the processing in operation S5.

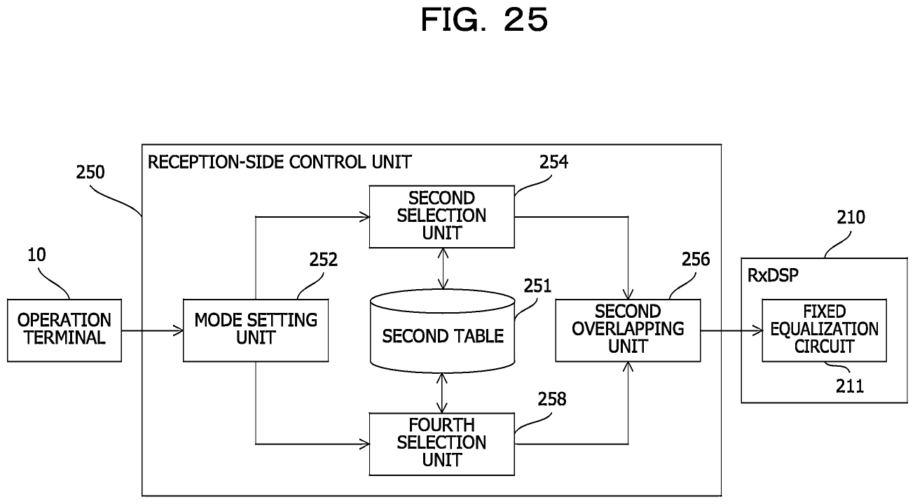

Next, a configuration and an operation of the reception-side control unit 250 according to the third embodiment will be described with reference to FIGS. 25 to 27. In FIG. 25, a configuration in the same manner as the configuration of the reception-side control unit 250 according to the first embodiment is denoted by the same reference signs, and the description thereof is omitted.

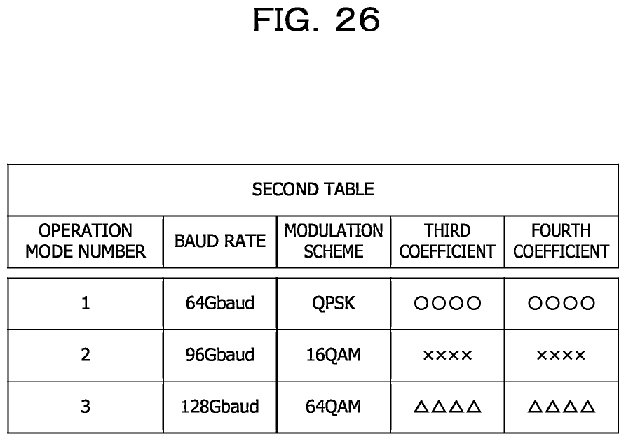

As illustrated in FIG. 25, the reception-side control unit 250 according to the third embodiment is different from the reception-side control unit 250 of the first embodiment, in that the reception-side control unit 250 does not include the coefficient setting unit 253 and the second generation unit 255 but further includes a fourth selection unit 258. As illustrated in FIG. 26, the second table 251 according to the third embodiment is different from the second table 251 according to the first embodiment, in that a fourth coefficient is associated with a third coefficient. The fourth selection unit 258 selects a fourth coefficient corresponding to an operation mode number set in the mode setting unit 252, from the second table 251. The fourth selection unit 258 outputs the selected fourth coefficient to the second overlapping unit 256. Therefore, the second overlapping unit 256 may overlap the third coefficient output from the second selection unit 254 and the fourth coefficient output from the fourth selection unit 258. For example, the second overlapping unit 256 may generate a second compensation coefficient.

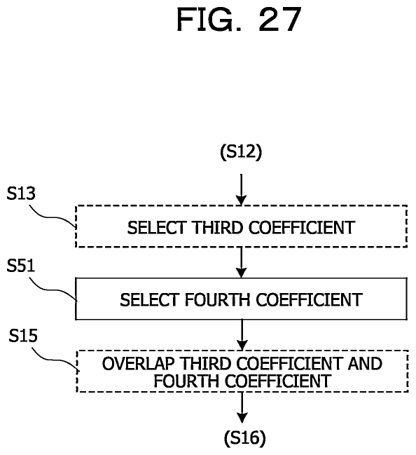

As illustrated in FIG. 27, when the second selection unit 254 executes the processing of operation S13, the fourth selection unit 258 selects a fourth coefficient as described above (operation S51), and outputs the fourth coefficient to the second overlapping unit 256. Therefore, the second overlapping unit 256 may execute the processing of operation S15.

As described above, with the third embodiment, it is possible to specify the second coefficient in accordance with the operation mode number and to use the overlapping with the first coefficient, without setting the amplification target value for the optical transmission apparatus 100. Even when the second coefficient is not set for the optical reception apparatus 200, the fourth coefficient may be specified in accordance with the operation mode number and may be used to be overlapped on the third coefficient. Therefore, a setting burden on a person in charge of setting who operates the operation terminal 10 may be reduced. By omitting the setting processing of the amplification target value by the optical transmission apparatus 100 and omitting the setting processing of the second coefficient by the optical reception apparatus 200, a processing load may be reduced.

### Fourth Embodiment

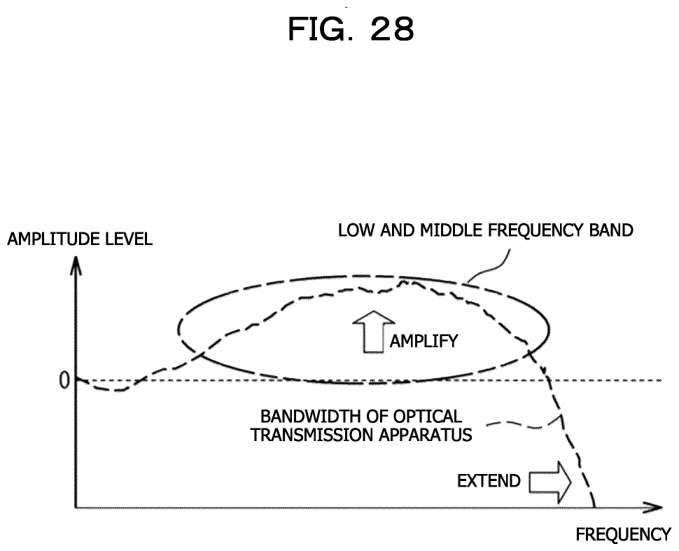

Next, a configuration and an operation of the transmission-side control unit 150 according to a fourth embodiment will be described with reference to FIGS. 28 to 33. According to the fourth embodiment, in order to expand a bandwidth on a high-frequency side in a band characteristic of the optical transmission apparatus 100, the CDM 130 (for example, driver circuit) described above gives a peaking characteristic to the band characteristic.

For example, as illustrated in FIG. 28, the CDM 130 (see FIG. 1) expands the bandwidth on the high-frequency side by amplifying an amplitude level in a low-frequency band or in a middle-frequency band. When the amplitude level in the low-frequency band or in the middle-frequency band is amplified, the bandwidth on the high-frequency side is expanded by this amplification. In this manner, the fourth embodiment is different from the first to third embodiments, in that CDM 130 gives the peaking characteristic to the band characteristic.

On the other hand, it is desirable that the excessive peaking characteristic is canceled out by de-emphasis occurring in the TxDSP 110 disposed at a previous stage of the CDM 130. The de-emphasis is, for example, a characteristic (or a method) of decreasing an amplitude level to cancel out the peaking characteristic. Meanwhile, since the de-emphasis is a characteristic of decreasing an amplitude level, the occurrence of the de-emphasis may cause a decrease in signal quality of an optical signal. Therefore, in the fourth embodiment, a filter (for example, digital filter) that cancels out a region in which de-emphasis appears is generated as the second coefficient, and the deterioration in signal quality of the optical signal is reduced.

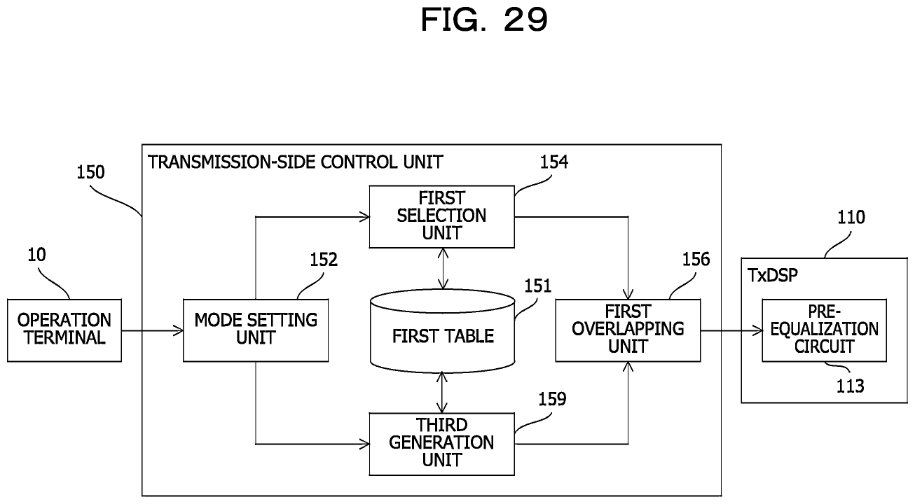

First, as illustrated in FIG. 29, the transmission-side control unit 150 according to the fourth embodiment includes a third generation unit 159, instead of the third selection unit 158 included in the transmission-side control unit 150 according to the third embodiment described with reference to FIG. 22. The first table 151 according to the fourth embodiment includes an operation mode number, a baud rate, a modulation scheme, and a first coefficient in association with each other, which are described with reference to FIG. 4.

From the first table 151, the third generation unit 159 acquires a baud rate corresponding to an operation mode number set in the mode setting unit 152. Although details will be described below, the third generation unit 159 generates another second coefficient different from the second coefficient described in the first embodiment to the third embodiment based on the acquired baud rate, and outputs the second coefficient to the first overlapping unit 156. Therefore, the first overlapping unit 156 may overlap the first coefficient output from the first selection unit 154 and the second coefficient output from the third generation unit 159. For example, the first overlapping unit 156 may generate a first compensation coefficient.

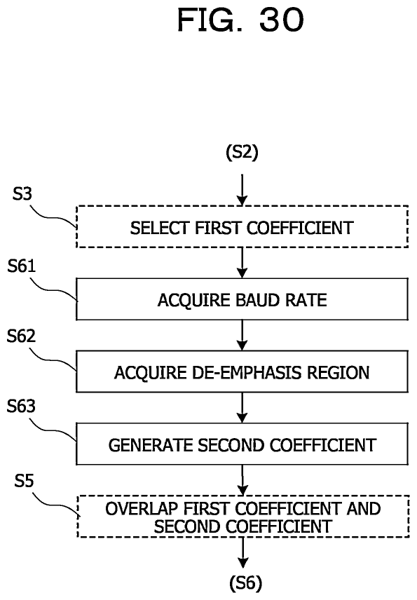

As illustrated in FIG. 30, when the first selection unit 154 executes the processing of operation S3, the third generation unit 159 acquires a baud rate from the first table 151 as described above (operation S61). When acquiring the baud rate, the third generation unit 159 acquires a de-emphasis region (operation S62).

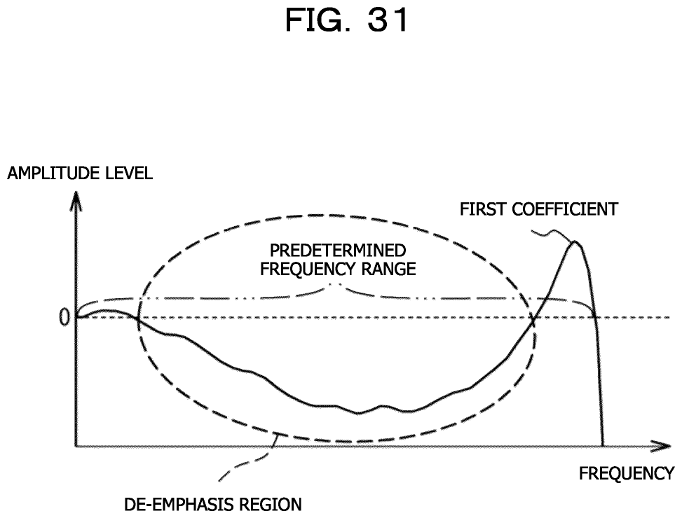

For example, first, the third generation unit 159 determines a predetermined frequency range for a first coefficient. For example, the third generation unit 159 calculates a frequency obtained by dividing the acquired baud rate by N hertz (N is a positive natural number), and determines the calculated frequency as the predetermined frequency range as illustrated in FIG. 31. When the predetermined frequency range is determined, the third generation unit 159 acquires, as the de-emphasis region, a region including, as a partial coefficient, a part of the first coefficient at which an amplitude level becomes negative in the predetermined frequency range.

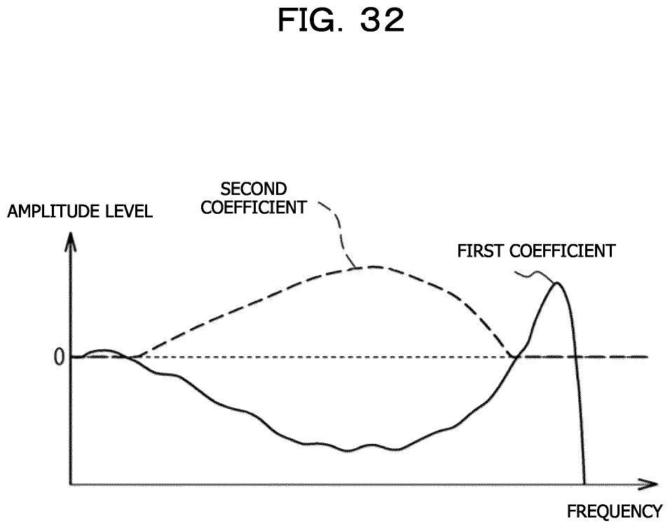

When the de-emphasis region is acquired, the third generation unit 159 generates a second coefficient (operation S63). For example, as illustrated in FIG. 32, a sign of the partial coefficient included in the de-emphasis region is inverted, and the second coefficient is generated as a filter that cancels out the partial coefficient. At this time, the third generation unit 159 may generate the second coefficient in which the amplitude level is uniformly set to 0 with respect to the remaining portion of the first coefficient in which the amplitude level is equal to or more than 0 in the predetermined frequency range.

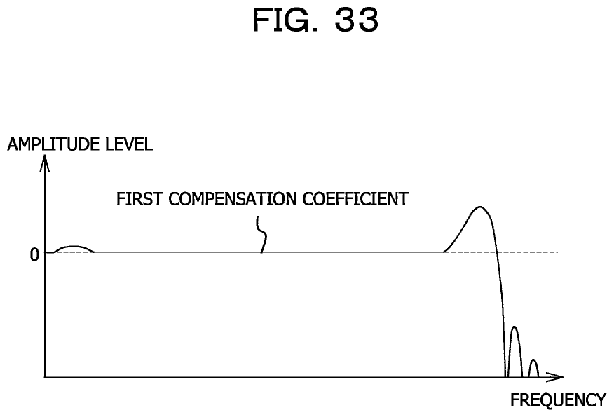

When generating the second coefficient, the first overlapping unit 156 overlaps the first coefficient and the second coefficient by the processing in operation S5. Therefore, the first overlapping unit 156 generates a first compensation coefficient described above. For example, as illustrated in FIG. 33, by overlapping the first coefficient and the second coefficient, the first compensation coefficient in which the amplitude level of the partial coefficient belonging to the de-emphasis region is increased is generated. When generating the first compensation coefficient, the first overlapping unit 156 executes the processing of operation S6 of setting the first compensation coefficient in the pre-equalization circuit 113 of the TxDSP 110, and the processing according to the fourth embodiment ends.

In this manner, with the fourth embodiment, even in a case where the de-emphasis region is generated by giving the peaking characteristic to the CDM 130, deterioration in signal quality of the data signal before being input to the DAC 120 (see FIG. 1) may be reduced. Therefore, it is possible to improve a transmission characteristic of the optical signal.

In the optical reception apparatus 200, a second compensation coefficient in which a fourth coefficient having a characteristic opposite to a characteristic of a second coefficient generated by the third generation unit 159 and a third coefficient described in the first embodiment to the third embodiment are overlapped with each other may be set in the fixed equalization circuit 211. In the same manner as in the first embodiment to the third embodiment, the fourth coefficient may be generated after the second coefficient is set in the reception-side control unit 250 by the operation terminal 10 or may be generated after the second coefficient is transmitted from the transmission-side control unit 150 to the reception-side control unit 250. The fourth coefficient may be generated in advance and associated with the third coefficient.

Although the third generation unit 159 generates the second coefficient that reduces the entire partial coefficient, the third generation unit 159 may generate the second coefficient that reduces a part of the partial coefficient. For example, the third generation unit 159 may generate the second coefficient that reduces at least the part of the partial coefficient.

The third generation unit 159 may generate a first compensation coefficient by multiplying the partial coefficient by n times (n<1) without generating the second coefficient. Even when the first compensation coefficient is generated in this manner, a decrease in signal quality of the data signal input to the DAC 120 may be reduced, and the transmission characteristic of the optical signal may be improved.

Although the preferred embodiments of the present disclosure have been described in detail above, the present disclosure is not limited to the specific embodiments according to the present disclosure, and various modifications and changes may be made within a scope of the gist of the present disclosure described in the claims.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An optical transmission and reception system comprising:
an optical transmission apparatus configured to:
acquire, in a frequency band of an electric data signal, from a first coefficient including a first characteristic for amplifying an amplitude level of the frequency band in a high-frequency side, a partial coefficient that represents a negative portion of the amplitude level in the first characteristic,
generate a second coefficient including a second characteristic that reduces at least a part of the partial coefficient,
generate a first compensation coefficient based on the first coefficient and the second coefficient,
compensate for a loss that occurs in the optical transmission apparatus for an electric data signal to be converted to an optical signal to be transmitted from the optical transmission apparatus, based on the first compensation coefficient; and
an optical reception apparatus configured to:
generate a second compensation coefficient based on a third coefficient including a third characteristic and a fourth coefficient including a fourth characteristic opposite to the second characteristic, the third coefficient and the fourth coefficient being coefficients for amplifying the electric data signal, and
compensate for a loss that occurs in an optical transmission line through which the optical reception apparatus receives the optical signal transmitted from the optical transmission apparatus, for the electric data signal, based on the second compensation coefficient.

2. The optical transmission and reception system according to claim 1,
wherein the optical transmission apparatus reduces the amplitude level of the electric data signal below an upper limit value of a converter that converts the electric data signal in a digital format to the electric data signal in an analog format.

3. The optical transmission and reception system according to claim 1,
wherein the optical transmission apparatus transmits the second coefficient to the optical reception apparatus, and the optical reception apparatus generates the fourth coefficient based on the received second coefficient.

4. The optical transmission and reception system according to claim 1,
wherein the optical transmission apparatus transmits the second coefficient to the optical reception apparatus by using a first signal with a lower baud rate than a baud rate of the electric data signal.

5. The optical transmission and reception system according to claim 1,
wherein the optical transmission apparatus transmits the second coefficient to the optical reception apparatus by using a second signal with a lower degree of multilevel than a degree of multilevel of the electric data signal.

6. The optical transmission and reception system according to claim 1,
wherein the optical transmission apparatus transmits the second coefficient to the optical reception apparatus by using a third signal with a modulated transmission frequency.

7. The optical transmission and reception system according to claim 1,
wherein the optical transmission apparatus determines the first coefficient in accordance with at least one of a baud rate and a modulation scheme of the electric data signal, and the optical reception apparatus determines the third coefficient in accordance with at least one of the baud rate and the modulation scheme of the electric data signal.

8. The optical transmission and reception system according to claim 7,
wherein the optical transmission apparatus determines the first coefficient and the second coefficient in accordance with at least one of the baud rate and the modulation scheme of the electric data signal, and the optical reception apparatus determines the third coefficient and the fourth coefficient in accordance with at least one of the baud rate and the modulation scheme of the electric data signal.

9. An optical transmission and reception method of an optical transmission and reception system including an optical transmission apparatus and an optical reception apparatus, the method comprising:
acquiring, in a frequency band of a data signal, from a first coefficient including a first characteristic in which an upward peak of an amplitude level of the frequency band exists in a high-frequency side, a partial coefficient that represents a negative portion of the amplitude level in the first characteristic,
generating a second coefficient including a second characteristic that reduces at least a part of the partial coefficient, and
compensating for a loss that occurs in the optical transmission apparatus, based on the first coefficient and the second coefficient, by the optical transmission apparatus,
wherein the optical transmission apparatus converts the data signal to an optical signal,
compensating for a loss that occurs in an optical transmission line through which the optical reception apparatus receives the optical signal transmitted from the optical transmission apparatus, based on a third coefficient including a third characteristic in which the amplitude level is decreased as a frequency is decreased in a partial band in a lower frequency side than the peak and a fourth coefficient including a fourth characteristic opposite to the second characteristic, by the optical reception apparatus.

10. An optical transmission apparatus comprising:
a first setting circuit configured to:
acquire, in a frequency band of an electric data signal, from a first coefficient including a first characteristic for amplifying an amplitude level of the frequency band in a high-frequency side, a partial coefficient that represents a negative portion of the amplitude level in the first characteristic,
generate a second coefficient including a second characteristic that reduces at least a part of the partial coefficient, and
generate a first compensation coefficient based on the first coefficient and the second coefficient; and
a first compensation circuit configured to compensate for a loss that occurs in the optical transmission apparatus for an electric data signal to be converted to an optical signal to be transmitted from the optical transmission apparatus to an optical reception apparatus, based on the first compensation coefficient,
wherein the optical reception apparatus is configured to:
generate a second compensation coefficient based on a third coefficient including a third characteristic and a fourth coefficient including a fourth characteristic opposite to the second characteristic, the third coefficient and the fourth coefficient being coefficients for amplifying the electric data signal, and
compensate for a loss that occurs in an optical transmission line through which the optical reception apparatus receives the optical signal transmitted from the optical transmission apparatus, for the electric data signal, based on the second compensation coefficient.
